(19) United States
(12) Patent Application Publication
(10) Pub. No.: US 2025/0220433 A1
(43) Pub. Date: Jul. 3, 2025

(54) MODEL GENERATION METHOD, INFORMATION PROCESSING METHOD, AND DEVICE

(71) Applicant: GUANGDONG OPPO MOBILE TELECOMMUNICATIONS CORP., LTD., Dongguan (CN)

(72) Inventors: Lu GAN, Dongguan (CN); Yulong FU, Dongguan (CN); Lulu LIU, Dongguan (CN); Tenglong WEI, Dongguan (CN); Cong SHI, Dongguan (CN)

(21) Appl. No.: 19/083,407

(22) Filed: Mar. 18, 2025

Related U.S. Application Data
(63) Continuation of application No. PCT/CN2022/120983, filed on Sep. 23, 2022.

(51) Int. Cl. H04W 12/121; G06N 20/00

(52) U.S. Cl. CPC H04W 12/121; G06N 20/00

(57) ABSTRACT

A model generation method, an information processing method, devices, and a computer-readable storage medium are provided. The model generation method includes the following. A first device receives one or more k-th layer sub-models, where k is a positive integer. The first device determines a target model based on the one or more k-th layer sub-models, where the target model is used for detecting whether communication data from a mobile network is intrusion-type data. The first device sends the target model.

### CROSS REFERENCE TO RELATED APPLICATION(S)

This application is a continuation of International Application No. PCT/CN2022/120983, filed Sep. 23, 2022, the entire disclosure of which is incorporated herein by reference.

### TECHNICAL FIELD

This disclosure relates to the field of communication, in particular to a model generation method, an information processing method, devices, a computer-readable storage medium, a computer program product, and a computer program.

### BACKGROUND

With the rapid development of the mobile internet, the application of mobile devices has gained popularity, application programs in mobile terminals have mushroomed, and there are more and more network attack events and intrusion behaviors against the mobile terminals. Therefore, how to accurately detect the intrusion behavior against a mobile network has become a problem to be solved.

### SUMMARY

A model generation method is provided in implementations of the present disclosure. The model generation method includes the following. A first device receives one or more k-th layer sub-models, where k is a positive integer. The first device determines a target model based on the one or more k-th layer sub-models, where the target model is used for detecting whether communication data from a mobile network is intrusion-type data. The first device sends the target model.

A model generation method is provided in implementations of the present disclosure. The model generation method includes the following. A second device sends a k-th layer sub-model, where k is a positive integer, and the k-th layer sub-model is used for determining a target model. The second device receives the target model, where the target model is used for detecting whether communication data from a mobile network is intrusion-type data.

A second device is provided in implementations of the present disclosure. The second device includes a processor and a memory. The memory is configured to store a computer program. The processor is configured to invoke and execute the computer program stored in the memory, to cause the second device to perform the followings. The second device sends a k-th layer sub-model, where k is a positive integer, and the k-th layer sub-model is used for determining a target model. The second device receives the target model, where the target model is used for detecting whether communication data from a mobile network is intrusion-type data.

### BRIEF DESCRIPTION OF THE DRAWINGS

FIG. 1 is a schematic diagram of an application scenario according to implementations of the present disclosure.

FIG. 2 is a schematic flowchart I of a model generation method according to implementations of the present disclosure.

FIG. 3 is a schematic flowchart II of a model generation method according to implementations of the present disclosure.

FIG. 4 is a schematic flowchart of processing of model aggregation according to implementations of the present disclosure.

FIG. 5 is a schematic flowchart III of a model generation method according to implementations of the present disclosure.

FIG. 6 is a schematic flowchart of processing of accuracy calculation according to implementations of the present disclosure.

FIG. 7 is an exemplary flowchart of a model generation method according to implementations of the present disclosure.

FIG. 8 is yet another exemplary flowchart of a model generation method according to implementations of the present disclosure.

FIG. 9 is still another exemplary flowchart of a model generation method according to implementations of the present disclosure.

FIG. 10 is another exemplary flowchart of a model generation method according to implementations of the present disclosure.

FIG. 11 is a schematic flowchart of an information processing method according to an implementation of the present disclosure.

FIG. 12 is a schematic diagram of a scenario that combines model generation and information processing according to an implementation of the present disclosure.

FIG. 13 is a schematic block diagram of a first device according to an implementation of the present disclosure.

FIG. 14 is a schematic block diagram of a second device according to another implementation of the present disclosure.

FIG. 15 is a schematic block diagram of an electronic device according to another implementation of the present disclosure.

FIG. 16 is a schematic block diagram of a communication device according to implementations of the present disclosure.

FIG. 17 is a schematic block diagram of a chip according to implementations of the present disclosure.

FIG. 18 is a schematic block diagram of a communication system according to implementations of the present disclosure.

### DETAILED DESCRIPTION

The following will describe technical solutions of implementations of the present disclosure with reference to accompanying drawings in implementations of the present disclosure.

The technical solutions of implementations of the present disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) communication system, other communication systems, etc.

Generally speaking, a conventional communication system generally supports a limited number (quantity) of connections and therefore is easy to implement. However, with the development of communication technology, a mobile communication system will not only support conventional communication but also support, for example, device-to-device (D2D) communication, machine-to-machine (M2M) communication, machine type communication (MTC), vehicle-to-vehicle (V2V) communication, vehicle to everything (V2X) communication, etc. Implementations of the present disclosure can also be applied to these communication systems.

In a possible implementation, the communication system in implementations of the present disclosure may be applied to a carrier aggregation (CA) scenario, or may be applied to a dual connectivity (DC) scenario, or may be applied to a standalone (SA) network deployment scenario.

In a possible implementation, the communication system in implementations of the present disclosure is applicable to an unlicensed spectrum, and an unlicensed spectrum may be regarded as a shared spectrum. Or the communication system in implementations of the present disclosure is applicable to a licensed spectrum, and a licensed spectrum may be regarded as a non-shared spectrum.

Various implementations of the present disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, a terminal device in a future evolved public land mobile network (PLMN), etc.

In implementations of the present disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In implementations of the present disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, a wireless terminal device in smart home, etc.

By way of explanation rather than limitation, in implementations of the present disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In implementations of the present disclosure, the network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, a network device in a future evolved PLMN, a network device in an NTN, etc.

By way of explanation rather than limitation, in implementations of the present disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In implementations of the present disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, etc. These small cells are characterized by small coverage and low transmission power and are adapted to provide data transmission service with high-rate.

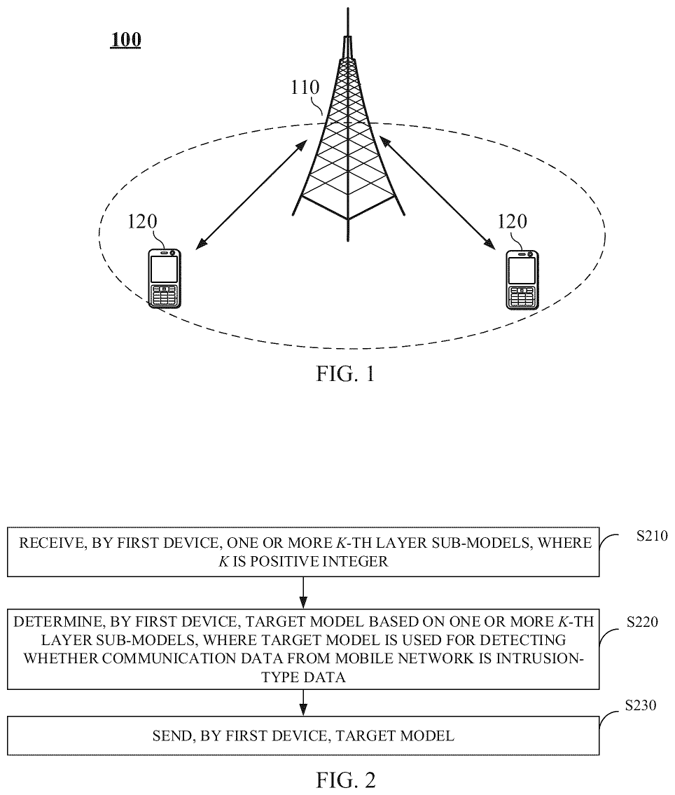

FIG. 1 exemplarily illustrates a communication system 100. The communication system 100 includes a network device 110 and two terminal devices 120. In a possible implementation, the communication system 100 can include multiple network devices 110, and there can be other quantities of terminal devices 120 in the coverage of each of the network devices 110, which is not limited in the present disclosure.

In a possible implementation, the communication system 100 can further include other network entities such as a mobility management entity (MME), an access and mobility management function (AMF), etc., which is not limited in the present disclosure.

The network device can further include an access network (AN) device and a core network (CN) device. That is, the wireless communication system further includes multiple CNs for communicating with the AN device. The AN device may be an evolutional node B (which can be referred to as “eNB” or “e-NodeB” for short), a macro base station, a micro base station (also referred to as “small base station”), a pico base station, an access point (AP), a transmission point (TP), a new generation Node B (gNodeB), etc., in the LTE system, the NR system, or an authorized auxiliary access long-term evolution (LAA-LTE) system.

It can be understood that, in implementations of the present disclosure, a device with communication functions in a network/system can be referred to as “communication device”. Taking the communication system illustrated in FIG. 1 as an example, the communication device may include a network device and a terminal device that have communication functions. The network device and the terminal device can be the devices in implementations of the present disclosure, which will not be repeated herein. The communication device may further include other devices such as a network controller, an MME, or other network entities in the communication system, which is not limited in the present disclosure.

It can be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

It can be understood that, “indication” referred to in implementations of the present disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates (′, and B can be obtained according to (′; or may mean that there is an association relationship between A and B.

In the elaboration of implementations of the present disclosure, the term “correspondence” may mean that there is a direct or indirect correspondence between the two, may mean that there is an association between the two, may mean a relationship of indicating and indicated or configuring and configured, etc.

In order to better understand technical solutions of implementations of the present disclosure, technical solutions related to the implementations of the present disclosure will be elaborated below. The following related art as an optional scheme can be arbitrarily combined with the technical solutions of implementations of the present disclosure, which shall all belong to the protection scope of implementations of the present disclosure. Implementations of the present disclosure include at least some of the following.

FIG. 2 is a schematic flowchart of a model generation method according to an implementation of the present disclosure. The method includes at least part of the following.

S210, a first device receives one or more k-th layer sub-models, where k is a positive integer.

S220, the first device determines a target model based on the one or more k-th layer sub-models, where the target model is used for detecting whether communication data from a mobile network is intrusion-type data.

S230, the first device sends the target model.

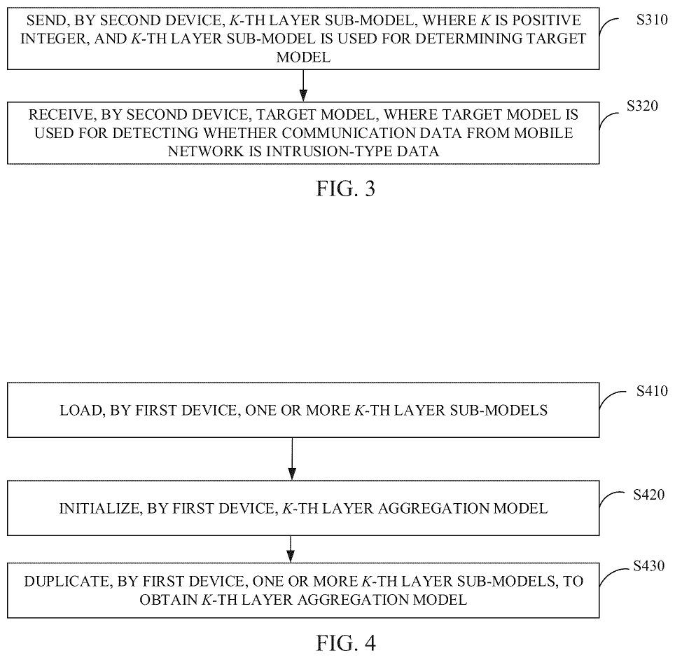

FIG. 3 is a schematic flowchart of a model generation method according to an implementation of the present disclosure. The method includes at least part of the following.

S310, a second device sends a k-th layer sub-model, where k is a positive integer, and the k-th layer sub-model is used for determining a target model.

S320, the second device receives the target model, where the target model is used for detecting whether communication data from a mobile network is intrusion-type data.

In this implementation, the first device and the second device can vary with scenarios.

Optionally, the first device can be a network device, and the second device can be a terminal device. There may be one or more second devices. It can also be noted that in the case where the first device is the network device and the second device is the terminal device, downlink information sent to the second device from the first device can be carried in any one of a system broadcast message, radio resource control (RRC) signaling, downlink control information (DCI), and media access control (MAC) control element (CE). Uplink information sent to the first device from the second device can be carried in any one of RRC signaling and MAC CE.

The network device is one of: an AN device, a CN device, and a server.

In an example, the network device can be the AN device, such as a base station, a gNB, an eNB, etc.

In another example, for a local breakout scenario, the network device can be the CN device. Preferably, the CN device can specifically be a packet data network gateway (PGW, or PDN GateWay).

. In yet another example, for an edge computing scenario, the network device can be the server. Preferably, the server can be an edge application server (EAS).

It can be understood that the above is only several possible exemplary descriptions of the first device being the network device. In actual processing, the first device can also be other types of network devices, which are not listed herein.

Optionally, both the first device and the second device are terminal devices, and there may be one or more second devices, which is not limited in this implementation. The first device can communicate with the one or more second devices. For example, the first device can be in sidelink (SL) communication with the one or more second devices.

In this case, the first device can be a master node, and each of the one or more second devices can be a child node.

The first device can be a device selected as the master node from multiple terminal devices. The multiple terminal devices can be all terminal devices in the coverage of the same first network device. The first network device can be a network device of a network where the multiple terminal devices are located. For example, the first network device can be a base station of the network where the multiple terminal devices are located.

The selection of the first device from the multiple terminal devices can be performed by the first network device, and a manner of selecting the first device (i.e., selecting the master node) can include the following. One terminal device is selected as the master node from the multiple terminal devices based on performance information of each of the multiple terminal devices, and the selected terminal device is the first device.

One terminal device is selected as the master node from the multiple terminal devices based on the performance information of each of the multiple terminal devices, which means that a terminal device with the optimal performance is selected as the master node from the multiple terminal devices based on the performance information of each of the multiple terminal devices. If there are several terminal devices with the optimal performance among the multiple terminal devices, any one of the several terminal devices with the optimal performance can be selected as the master node.

Exemplarily, the performance information of the terminal device can include a free memory and/or a memory. Further, the performance information of the terminal device can include at least one of: a central processing unit (CPU) model of the terminal device, or an operating system of the terminal device. The free memory can refer to the total amount of memory that is not currently used by the terminal device, and the memory refers to the total memory capacity of the terminal device. Both the free memory and the memory can be expressed in gigabyte (GB). In this example, the terminal device with the optimal performance is selected as the master node from the multiple terminal devices based on the performance information of each of the multiple terminal devices, which means that a terminal device with the largest free memory (or memory) is selected as the master node from the multiple terminal devices based on the performance information of each of the multiple terminal devices. If there are several terminal devices with the largest free memory (or memory) among the multiple terminal devices, any one of the several terminal devices with the largest free memory (or memory) can be selected as the master node.

For example, there are four terminal devices denoted as UE1, UE2, UE3, and UE4, and performance information of the four UEs can be illustrated in Table 1.

TABLE 1

| | CPU | Operating system | Memory |
|---|---|---|---|
| UE1 | ARM 15 | Operating system A | 4 GB |
| UE2 | 1.5 GHz | | 2 GB |
| UE3 | | | 2 GB |
| UE4 | | | 2 GB |

UE1 with the largest free memory (or memory) can be selected as the master node from the multiple terminal devices based on the performance information of the four UEs illustrated in Table 1.

The first network device can send identity indication information to the first device, where the identity indication information indicates that the first device is the master node for this processing. Accordingly, after the first device receives the identity indication information, the first device can determine itself as the master node.

In addition, the first network device can further determine one or more terminal devices other than the first device among the multiple terminal devices as one or more second devices, and send master node indication information to each of the one or more second devices, where the master node indication information is used to inform the second device that the first device is the master node for this processing. The master node indication information can include at least one of: a related identification of the first device, an internet protocol (IP) address of the first device, or a port number of the first device.

For another example, there are four terminal devices denoted as UE1, UE2, UE3, and UE4, and IP addresses and port numbers of the four UEs can be illustrated in Table 2.

TABLE 2

| Device name | IP addresses: port numbers |
|---|---|
| UE1 | 192.168.0.1: 8000 |
| UE2 | 192.168.0.2: 8000 |
| UE3 | 192.168.0.3: 8000 |
| UE4 | 192.168.0.4: 8000 |

Performance information of any one of the four terminal devices can be carried in any one of: the RRC signaling, the MAC CE, etc., and sent to the first network device by the terminal device. The identity indication information and the master node indication information can be carried in any one of: the system broadcast message, the DCI, the RRC signaling, and the MAC CE.

Alternatively, the selection of the first device from the multiple terminal devices can be performed by any one of the multiple terminal devices. For example, one first device can be selected as the master node by any one of the multiple terminal devices in a manner similar to the foregoing. For example, the multiple terminal devices can pre-negotiate with each other to obtain a decision node. The decision node can obtain the performance information of each of the multiple terminal devices first, and then select one terminal device as the master node from the multiple terminal devices based on the performance information of each of the multiple terminal devices. In addition, the decision node can send the identity indication information to the master node, and send the master node indication information to other nodes except the master node. The content of the identity indication information and the content of the master node indication information are the same as those of the foregoing implementations, which are not repeated herein. A difference is that the identity indication information and the master node indication information are carried in an SL message. The SL message may be any one of: an SL RRC message, an SL MAC CE, etc., which are not listed herein.

Through the above processing, the first device can be ensured to be the device with the optimal performance, thereby ensuring a higher efficiency in performing the model generation method provided in implementations of the present disclosure.

After the first device (the master node) and the one or more second devices (the child nodes) are selected based on the foregoing processing, the following processing can further be performed. The first device sends a local dataset to each of the one or more second devices.

The first device sends the local dataset to each of the one or more second devices as follows. In the case where the first device does not train a local sub-model, the first device determines a local dataset used by each of the one or more second devices, and sends the local dataset used by each of the one or more second devices to a corresponding second device. Alternatively, in the case where the first device trains a local sub-model, the first device determines a local dataset used by itself and a local dataset used by each of the one or more second devices, and sends the local dataset used by each of the one or more second devices to the corresponding second device.

Data in different local datasets sent to different second devices are at least partially different. Each local dataset can include normal data and abnormal data, where the normal data refers to normal domain name data, and the abnormal data refers to domain generation algorithm (DGA) domain name data. For example, there are four terminal devices denoted as UE1, UE2, UE3, and UE4. If UE1 is the master node, UE1 selects 100,000 pieces of DGA domain name data and 100,000 pieces of normal domain name data as a local dataset of each UE for each of the four UEs, respectively, where 100,000 pieces of DGA domain name data selected for a UE are not completely identical to 100,000 pieces of DGA domain name data selected for any one of other UEs, and 100,000 pieces of normal domain name data for a UE are not completely identical to 100,000 pieces of normal domain name data for any one of other UEs.

In the following, unless otherwise specified, the local dataset refers to a local dataset saved by each device. For example, if the local dataset is mentioned in the description of the processing of the first device, unless otherwise described, the local dataset refers to a local dataset saved by the first device. Similarly, if the local dataset is mentioned in the description of the processing of any one of the one or more second devices, unless otherwise described, the local dataset refers to a local dataset saved by the second device.

The local dataset can be used to obtain a local training set and a local test set. In other words, the local test set is partial data in the local dataset, and the local training set is partial data in the local dataset.

The local dataset includes one or more sample data, where each of the one or more sample data includes: a label indicating whether each of the one or more sample data is an intrusion behavior, and a feature value, or each of the one or more sample data includes: a feature value of each of two sub-data, and a label indicating whether the two sub-data are the same type of data.

Each second device can preprocess data based on its own local dataset, and obtain a local training set and a local test set based on a preprocessed local dataset. Alternatively, the first device can preprocess data based on its own local dataset and obtain a local training set and a local test set based on a preprocessed local dataset, and each second device can preprocess data based on its own local dataset and obtain a local training set and a local test set based on a preprocessed local dataset.

Optionally, any device can preprocess data by setting a label for each data in the local dataset to obtain each sample data in the preprocessed local dataset. The label set for each data is used for determining whether the date is an intrusion behavior. For example, the label set for each data can indicate whether the data is normal data or abnormal data (or DGA domain name data). More specifically, the label can be an indication value or can be descriptive information. For example, descriptive information attack can indicate that the data is the abnormal data (or the intrusion-type data).

Any device mentioned above is the first device or any one of the one or more second devices, and in the following, unless otherwise specified, any device or each device refers to the first device or any one of the one or more second devices, which is not repeated herein. 83. For example, any sample data can include a label and a feature value. For example, any sample data is represented as (f1, f2, f3, . . . , f50; attack), where f1-f50 means that there are 50 feature values, and attack is a label that indicates an intrusion behavior.

Optionally, any device can preprocess data as follows. Any two data in the local dataset are paired and labeled, domain names of the two paired data are concatenated end-to-end, and the data with domain names concatenated end-to-end is taken as one sample date in the preprocessed local dataset. All data is processed in the foregoing manner, to obtain the preprocessed local dataset.

Any two data in the local dataset are paired and labeled as follows. Any two data in the local dataset (the normal data and the abnormal data) are paired to obtain paired data. When the paired data are the same type of data, a corresponding label is set to a first value, otherwise, the corresponding label is set to a second value. In other words, one sample data includes the paired data and the label, where the label indicates whether the pair data are the same type of data or different types of data (i.e., data in different types).

The same type of data refers to both two date are normal data or abnormal data, and the different types of data indicate that one is normal data and the other is abnormal data. The first value may be 0, and the second value may be 1. Alternatively, the first value may be 1, and the second value may be 0. As long as the first value is different from the second value, they are all within the scope of protection of the implementations of the present disclosure.

The amount of data in the local dataset can be expanded by pairing any two data in the foregoing processing. For example, initially, there are four data in the local dataset {a, b, c, d}, and after any two data are paired, there are six data in the local dataset {ab, ac, ad, bc, bd, cd}, thereby expanding the amount of data.

The data with domain names concatenated end-to-end is taken as one sample date in the preprocessed local dataset as follows. When the data with domain names concatenated end-to-end has a length shorter than a specified length, the data with domain names concatenated end-to-end is padded to obtain data with the specified length, the data with the specified length is converted into sample data in a numerical sequence, and the sample data in the numerical sequence is taken as one sample data in the preprocessed local dataset. Alternatively, when the data with domain names concatenated end-to-end has a length equal to the specified length, the data with the specified length is converted into the sample data in the numerical sequence, and the sample data in the numerical sequence is taken as one sample data in the preprocessed local dataset.

The specified length can be set according to the actual situation, for example, the specified length may be 100. It can also be pointed out that if the data with domain names concatenated end-to-end has a length shorter than the specified length, a character is padded between the paired domain names. The character can be set according to the actual situation, for example, the character may be a or other characters, which are not listed herein.

The data with the specified length is converted into the sample data in the numerical sequence, which means that the data with the specified length is converted into the sample data in the numerical sequence based on a conversion dictionary. The conversion dictionary can be preset, and the content of the preset conversion dictionary in each device is the same. Exemplarily, the conversion dictionary can include numbers corresponding to each character or letter. For example, the content of a conversion dictionary D is: {′a′: 1, ‘b’: 2, ‘c’: 3, ‘d’: 4, ‘e’: 5, ‘f’: 6, ‘g’: 7, ‘h’: 8, ‘i’: 9, ‘j’: 10, ‘k’: 11, ‘l’: 12, ‘m’: 13, ‘n’: 14, ‘o’: 15, ‘p’: 16, ‘q’: 17, ‘r’: 18, ‘s’: 19, ‘t’: 20, ‘u’: 21, ‘v’: 22, ‘w’: 23, ‘x’: 24, ‘y’: 25, ‘z’: 26, ‘-’: 27, ‘_’: 28, ‘1’: 29, ‘2’: 30, ‘3’: 31, ‘4’: 32, ‘5’: 33, ‘6’: 34, ‘7’: 35, ‘8’: 36, ‘9’: 37, ‘0’: 38, “.”: 39, ‘a’: 0}.

The local training set and the local test set are obtained based on the preprocessed local dataset as follows. All sample data in the preprocessed local dataset are divided to obtain the local training set and the local test set. The division may be in accordance with a preset ratio. For example, 70% of the sample data are taken as training samples in the local training set, and the remaining 30% of the sample data are taken as test samples in the local test set. It can be understood that this is only an exemplary illustration, and that the preset ratio can be set in accordance with the actual situation, such as both 50%, or other ratios, which are not limited herein.

After the foregoing processing is completed, each second device can begin to perform current layer sub-model training.

The k-th layer sub-model training is performed based on a (k−1)-th layer aggregation model. In the case where k is equal to 1, the (k−1)-th layer aggregation model (i.e., a 0-th layer aggregation model) can be a preset initial sub-model. Since the k-th layer sub-model training may be any one sub-model training, only one of the training is illustrated in the following, and other training will not be repeated herein.

The k-th layer sub-model training can include the following. Each training sample in the local training set is input into the (k−1)-th layer aggregation model, to obtain a result output from the (k−1)-th layer aggregation model. A loss function is determined based on the result output from the (k−1)-th layer aggregation model and a label of the training sample, and a model parameter of the (k−1)-th layer aggregation model is updated based on the backpropagation of the loss function. After the (k−1)-th layer aggregation model training is completed, a k-th layer sub-model is obtained. The condition for determining convergence can be that the number (quantity) of times the sub-model is trained reaches a preset number of times. The preset number of times can be preset, for example, it may be 100 times, or more or less, which is not limited herein.

The sub-model can include at least one of: one or more random forests, or one or more completely random forests. Preferably, the sub-model can include: multiple random forests and multiple completely random forests. Further, the number of the multiple random forests may be even, and the number of multiple completely random forests may also be even.

In a case, the training sample in the local training set is single data, and the output result indicates that the training sample is normal data or abnormal data or indicates whether the training sample is an invasion behavior (or invasion data).

In another case, the training sample in the local training set is generated based on the paired data, and the pairing manner is illustrated in the foregoing implementations, which will not be repeated herein. In this case, the output result indicates that two data in one training sample are of the same type or different types. For example, if the sub-model or the aggregation model is an Siamese network, the paired data in the training sample are input into two sub-networks in the Siamese network, respectively, and the output result is that the two data in the paired data in the training sample are of the same type or different types. For example, two random forests and two completely random forests can be included in the initial sub-model, and the initial sub-model can be the Siamese network. For example, the Siamese network is composed of two identical sub-networks, and each of the two sub-networks can include one random forest and/or one completely random forest.

In this solution, the random forest and/or the completely random forest can also form the Siamese network, which can ensure a better classification effect and stronger generalization ability.

After each second device completes the k-th layer sub-model training, the operations at S310, i.e., sending the k-th layer sub-model, can be performed. The k-th layer sub-model can be sent as follows. The second device sends the k-th layer sub-model to the first device, where the k-th layer sub-model can be represented in a format of json string.

The first device receives one or more k-th layer sub-models at S210 as follows. The first device receives a k-th layer sub-model from each of the one or more second devices. Accordingly, the first device sends the target model at S230 as follows. The first device sends the target model to each of the one or more second devices.

In other words, the first device can simultaneously communicate with the one or more second devices, and in a preferable example, the number of the one or more second devices is greater than or equal to 2. In the one or more k-th sub-models, different k-th layer sub-models are from different second devices.

In a possible implementation, the first device determines the target model based on the one or more k-th layer sub-models as follows. The first device generates a k-th layer aggregation model based on the one or more k-th layer sub-models. When the k-th layer aggregation model is determined to meet a preset condition, the first device determines the k-th layer aggregation model as the target model.

When the first device sends the target model, the method further includes the following. The first device sends first indication information to each of the one or more second devices, where the first indication information indicates to detect, based on the target model, whether the communication data from the mobile network is the intrusion-type data. Accordingly, when the second device receives the target model, the method further includes the following. The second device receives the first indication information, where the first indication information indicates to detect, based on the target model, whether the communication data from the mobile network is the intrusion-type data.

The target model includes at least one of: one or more random forests, or one or more completely random forests.

In addition, the method further includes the following. When the k-th layer aggregation model fails to meet the preset condition, the first device sends the k-th layer aggregation model to each of the one or more second devices.

When the first device sends the k-th layer aggregation model to each of the one or more second devices, the method further includes the following. The first device sends second indication information to each of the one or more second devices, where the second indication information indicates that a (k+1)-th layer sub-model is to be generated based on the k-th layer aggregation model. Accordingly, at the second device, the method further includes the following. The second device receives the k-th layer aggregation model and the second indication information, where the second indication information indicates that the (k+1)-th layer sub-model is to be generated based on the k-th layer aggregation model.

Optionally, the first device does not perform sub-model training, and the first device obtains the k-th layer aggregation model only by aggregating the k-th layer sub-model sent by each of the one or more second devices.

The first device generates the k-th layer aggregation model based on the one or more k-th layer sub-models as follows. An empty k-th layer aggregation model is created. The one or more k-th layer sub-models are duplicated to the empty k-th layer aggregation model, to generate the k-th layer aggregation model. Specific operations are illustrated in FIG. 4.

, the first device loads the one or more k-th layer sub-models.

Specifically, the first device can load the k-th layer sub-model uploaded by each of the one or more second devices in turn via a joblib.load ( ) function and store them in a local sub-model list.

S420, the first device initializes the k-th layer aggregation model.

Specifically, the first device can initialize the k-th layer aggregation model as a CascadeForestClassifier model, and synchronize the initialized k-th layer aggregation model with attribute-related parameters of each of the one or more k-th layer sub-models. Since the attribute-related parameters of each of the one or more k-th layer sub-models need be the same, it is only necessary to synchronize the k-th layer aggregation model with attribute-related parameters of any one of the one or more k-th layer sub-models.

In a preferable example, the sub-model can include at least one of: one or more random forests, or one or more completely random forests. Accordingly, the attribute-related parameters can include at least one of: the number of random forests, the number of completely random forests, the maximum number of trees in each random forest, the maximum number of trees in each completely random forest, the maximum depth of the trees, the number k of layers, etc. The maximum number of trees in each random forest in one sub-model can be the same, that is, the maximum number of trees in each random forest is the same. The maximum number of trees in each completely random forest in one sub-model can be the same, that is, the maximum number of trees in each completely random forest is the same. The maximum depth of the trees can be classified into the maximum depth of the trees in a random forest and the maximum depth of the trees in a completely random forest, both of which can be the same or different, which is not limited herein.

S430, the first device duplicates the one or more k-th layer sub-models, to obtain the k-th layer aggregation model.

The first device duplicates the one or more k-th layer sub-models as follows. The first device duplicates the one or more k-th layer sub-models based on a preset format.

The preset format can include at least one of: a first preset format, or a second preset format.

The first preset format is used when the random forest is duplicated, and the first preset format includes at least one of: the number k of layers, a serial number of the random forest, or model parameters of the random forest. For example, when any random forest is duplicated, the following format can be used: Estimators [the number k of layers-classifier serial number (i.e., the serial number of the random forest)-model parameters of the random forest].

The second preset format can be used when the completely random forest is duplicated, and the second preset format includes at least one of: the number k of layers, a serial number of the completely random forest, or model parameters of the completely random forest. For example, when any completely random forest is duplicated, the following format can be used: Estimators [the number k of layers-classifier serial number (i.e., the serial number of the completely random forest)-model parameters of the completely random forest].

After the first device obtains the k-th layer aggregation model, the first device determines whether the k-th layer aggregation model meets the preset condition. Based on a determination that the k-th layer aggregation model meets the preset condition, the first device determines the k-th layer aggregation model as the target model, and sends the target model to each of the one or more second devices.

The target model includes at least one of: one or more random forests, or one or more completely random forests.

It can be noted that the number of random forests in the target model is the sum of the number of random forests in each of multiple k-th layer sub-models, and similarly, the number of completely random forests in the target model is the sum of the number of the completely random forests in each of the multiple k-th layer sub-models.

Alternatively, in the case where different k-th layer sub-models have a same random forest and/or a same completely random forest, the first device can also perform deduplication on the same random forest and/or the same completely random forest. In this case, the number of random forests in the target model is the sum of the number of deduplicated random forests in each of the multiple k-th layer sub-models, and similarly, the number of completely random forests in the target model is the sum of the number of deduplicated completely random forests in each of the multiple k-th layer sub-models.

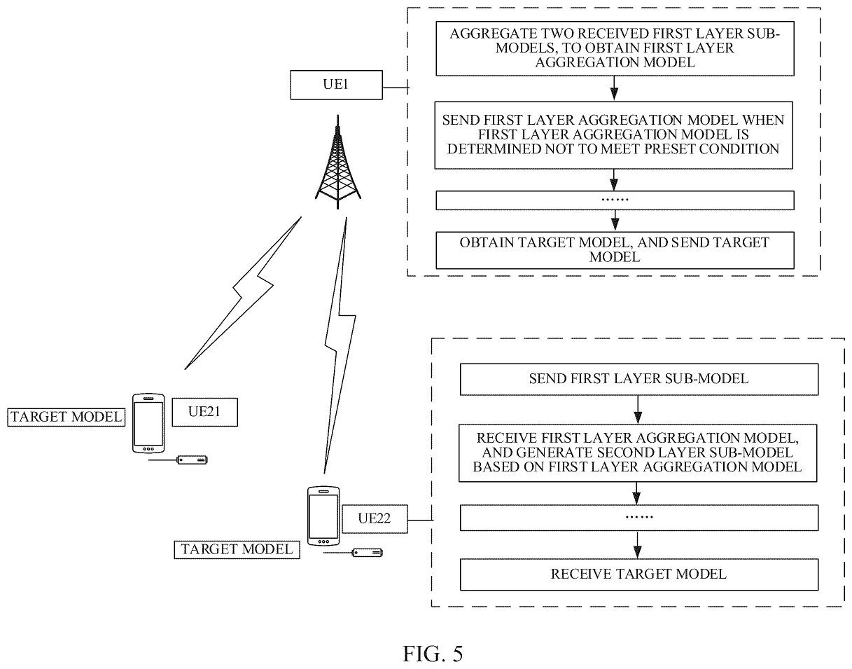

For example, reference can be made to FIG. 5, where the first device is UE1, and the second devices can be UE21 and UE22. As can be seen from FIG. 5, UE1 performs data interaction with two UEs (i.e., UE 21 and UE22). Specifically, UE21 and UE22 each send a first layer sub-model to UE1. UE1 aggregates two received first layer sub-models to obtain a first layer aggregation model. When the first layer aggregation model is determined not to meet the preset condition, UE1 sends the first layer aggregation model to UE21 and UE22. UE21 and UE22 each receive the first layer aggregation model and generate a second layer sub-model based on the first layer aggregation model, and so on. Until UE1 determines that the target model is obtained, UE1 sends the target model to UE21 and UE22, and accordingly, UE21 and UE22 each receive the target model. It can be understood that in FIG. 5, for brevity, only a schematic flowchart of operations between UE1 and UE22 is illustrated, and the processing of UE21 is similar to that of UE22, which is not repeated herein. It can also be understood that UE1 in FIG. 5 can also be replaced with a network device, which is not repeated herein.

Optionally, the first device performs sub-model training, and the first device obtains the k-th layer aggregation model by aggregating the k-th layer sub-model sent by each second device and a k-th layer local sub-model.

The method further includes the following. The first device generates the k-th layer local sub-model based on the local training set and the (k−1)-th layer aggregation model, where the local training set is partial data in the local dataset. The first device generates the k-th layer aggregation model based on the one or more k-th layer sub-models as follows. The first device generates the k-th layer aggregation model based on the k-th layer local sub-model and the one or more k-th layer sub-models.

The processing of the first device sending the local dataset in the foregoing implementations has illustrated that the first device can also obtain its own local training set and local test set, and thus the first device can also obtain the k-th layer local sub-model through training based on the local training set and the (k−1)-th layer aggregation model. For the processing of the first device obtaining the k-th layer local sub-model through training by itself, reference can be made to the processing of the second device obtaining the k-th layer sub-model through training, which will not be repeated herein.

The first device generates the k-th layer aggregation model based on the k-th layer local sub-model and the one or more k-th layer sub-models as follows. An empty k-th layer aggregation model is created. The one or more k-th layer sub-models and the k-th layer local sub-models are duplicated to the empty k-th layer aggregation model, to generate the k-th layer aggregation model. For the specific processing, the processing of the k-th layer local sub-model is added into the operations at S410 to S430, which will not be repeated herein.

The preset condition can include that accuracy of the k-th layer aggregation model is greater than a first threshold.

Alternatively, the preset condition includes that a difference between the accuracy of the k-th layer aggregation model and accuracy of the (k−1)-th layer aggregation model is less than a second threshold.

The preset condition can be preset by the first device, or can be configured by the first network device for the first device. The preset condition is configured by the first network device for the first device, which is particularly applicable to a scenario in which the first device is a terminal device. In this scenario, the first network device can specifically be an AN device of a network accessed by the first device. For example, the first network device can be a service base station (or a service gNB, or a service eNB) of the first device.

The first threshold can be set according to the actual situation. For example, the first threshold may be 95%, 98%, or greater or smaller, which is not repeated herein. The second threshold can also be set according to the actual situation, for example, it may be 0.05%, 0.01%, or greater or smaller, which is not repeated herein.

At least one of the first threshold and the second threshold can be preset by the first device or configured by the network device for the first device.

In the case where at least one of the first threshold and the second threshold is configured by the network device for the first device, at least one of the first threshold and the second threshold can be carried in at least one of a DCI, a system broadcast message, RRC signaling, and an MAC CE. At least one of the first threshold and the second threshold is configured by the first network device for the first device, which is particularly applicable to the scenario in which the first device is the terminal device. In this scenario, the first network device can specifically be the AN device of the network accessed by the first device.

Optionally, after the first device obtains the k-th layer aggregation model through aggregation, if the accuracy of the k-th layer aggregation model is determined to be greater than the first threshold, the k-th layer aggregation model can be determined as the target model, otherwise, the k-th layer aggregation model is not the target model, and the (k+1)-th training is required.

Optionally, after the first device obtains the k-th layer aggregation model through aggregation, if the difference between the accuracy of the k-th layer aggregation model and the accuracy of the (k−1)-th layer aggregation model is determined to be less than the second threshold, the k-th layer aggregation model can be determined as the target model, otherwise, the k-th layer aggregation model is not the target model, and the (k+1)-th training is required. It is noted that in this manner, the first device needs to save the accuracy of the (k−1)-th layer aggregation model. Alternatively, the first device can save the (k−1)-th layer aggregation model, and calculate the accuracy of the k-th layer aggregation model and the accuracy of the (k−1)-th layer aggregation model, respectively after obtaining the (k−1)-th layer aggregation model.

The accuracy of the k-th layer aggregation model can be determined by the first device based on the local test set.

The first device determines the accuracy of the k-th layer aggregation model based on the local test set. The local test set includes one or more test data, and each of the one or more test data include: a label indicating whether the test data is intrusion-type data, and a feature value. For a manner in which the first device obtains the local test set, reference can be made to the foregoing implementations, which is not repeated herein.

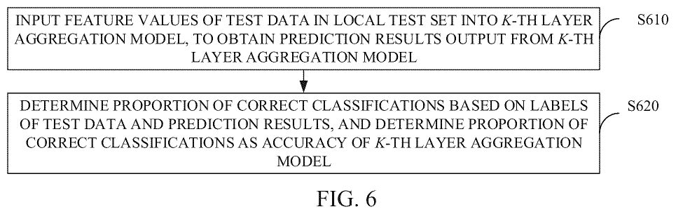

The processing of determining the accuracy of the k-th layer aggregation model based on the local test set can be illustrated in FIG. 6 as follows.

S610, feature values of the test data in the local test set are input into the k-th layer aggregation model, to obtain prediction results output from the k-th layer aggregation model.

. S620, a proportion of correct classifications is determined based on the labels of the test data and the prediction results, and the proportion of correct classifications is determined as the accuracy of the k-th layer aggregation model.

Specifically, classification accuracy can be evaluated with a confusion matrix, and the proportion of correct classifications, i.e., the accuracy of the k-th layer aggregation model, can be calculated by using the labels of the test data and the prediction results. A specific calculation formula is as follows.

$${ACC}_{k} = \frac{TP + TN}{TP + TN + FP + FN} * 100 \%$$

where ACC is the accuracy of the k-th layer aggregation model, TP is true positive, i.e., true is 0 and prediction is also 0, FP is false positive, i.e., true is 1 and prediction is 0, TN is true negative, i.e., true is 1 and prediction is also 1, and FN is false negative, i.e., true is 0 and prediction is 1.

It can be understood that the processing of the accuracy of the k-th layer aggregation model can be performed by using a specified number of test data in the local test set. The specified number can be set according to the actual situation. For example, the specified number may be all, may be 100, may be 80, etc. For example, if there are 200 test data in the local test set, all of the test data can be used for calculating the accuracy of the k-th layer aggregation model, or 150 test data can be randomly selected to be used for calculating the accuracy of the k-th layer aggregation model, etc., which are not listed herein.

The TP can be a specific number. For example, in 100 test data, there are 50 test data whose prediction result is normal data and whose label is also normal data. The TN can be a specific number. For example, in 100 test data, there are 30 test data whose prediction result is abnormal data and whose label is also abnormal data. The FP can be a specific number. For example, in 100 test data, there are 10 test data whose prediction result is normal data and whose label is abnormal data. The FN can be a specific number. For example, in 100 test data, there are 10 test data whose prediction result is abnormal data and whose label is normal data. Finally, the accuracy of the k-th layer aggregation model can be obtained as 80%.

The above illustrates the calculation of the accuracy of the k-th layer aggregation model. It can be understood that for the calculation of the accuracy of the (k−1)-th layer aggregation model, reference can be made to the calculation of the accuracy of the k-th layer aggregation model, which is not repeated herein.

Further, each second device performs the (k+1)-th training as follows.

The method can further include the following. The second device receives the k-th layer aggregation model and the second indication information, where the second indication information indicates that the (k+1)-th layer sub-model is to be generated based on the k-th layer aggregation model.

The method further includes the following. The second device generates the (k+1)-th layer sub-model based on an updated local training set and the k-th layer aggregation model.

Before each second device performs the (k+1)-th training, the method further includes the following. The second device inputs a j-th training sample in the local training set into the k-th layer aggregation model, to obtain a feature vector output from the k-th layer aggregation model, where the local training set is partial data in the local dataset, and j is a positive integer. The second device down-samples randomly one or more training feature values of the j-th training sample, to obtain a processed training feature value of the j-th training sample. The second device obtains a j-th training sample in the updated local training set based on the processed training feature value of the j-th training sample and the feature vector output from the k-th layer aggregation model.

The j-th training sample is any one of the training samples in the local training set, and since the processing is the same for each training sample in the local training set, the processing for other training samples are not illustrated one by one herein.

The one or more training feature values of the j-th training sample are down-sampled randomly, which can reduce the correlation between input data features of adjacent layers.

The j-th training sample in the updated local training set is obtained based on the processed training feature value of the j-th training sample and the feature vector output from the k-th layer aggregation model, which can mean that the processed training feature value of the j-th training sample and the feature vector output from the k-th layer aggregation model are concatenated to obtain the j-th training sample in the updated local training set. The concatenation can mean that the processed training feature value of the j-th training sample is followed by the feature vector output from the k-th layer aggregation model.

A result output from the k-th layer aggregation model is a class vector with the same format as a feature vector of input data. If the k-th layer aggregation model is not an aggregation model obtained through the last training, the feature vector of the input data is followed by the output class vector, to generate a transform feature vector, and the transform feature vector is used for training the next layer sub-model. Due to the variability of datasets in different scenarios, the number of sampling bits for randomly down-sampling the feature of the training set can be set independently according to the specific application scenarios. In this way, more local information of the data can be obtained, and the input data can be more random, thus increasing the generalization ability of the model. When the model converges, its classification effect will be better.

For example, for the k-th layer aggregation model, the training feature value of the j-th training sample is helloworld, the result output from the k-th layer aggregation model is 0, and helloworld and 0 are concatenated to generate a transform feature helloworld0 which is used for the (k+1)-th layer sub-model training. However, if the transform feature helloworld0 is directly used as input during the (k+1)-th layer sub-model training, the transform feature helloworld0 is approximately the same as the feature of the j-th training sample input into the k-th layer sub-model training, which makes the (k+1)-th layer sub-models and the k-th layer aggregation model almost the same. Therefore, feature random down-sampling needs to be performed on the feature value helloworld of the j-th training sample. For example, a character string hellorld is sampled randomly from helloworld, and then hellorld is concatenated with the result 0 output from the k-th layer aggregation model, to generate a transform feature hellorld0. If the transform feature hellorld0 is used for the (k+1)-th layer sub-model training, the the (k+1)-th layer sub-model will be different from the k-th layer aggregation model.

It can be understood that the above illustrates the (k+1)-th layer sub-model training by the second device. If the first device is involved in local sub-model training, the first device can also perform the same processing as that performed by the second device in the foregoing implementations, which is not repeated herein.

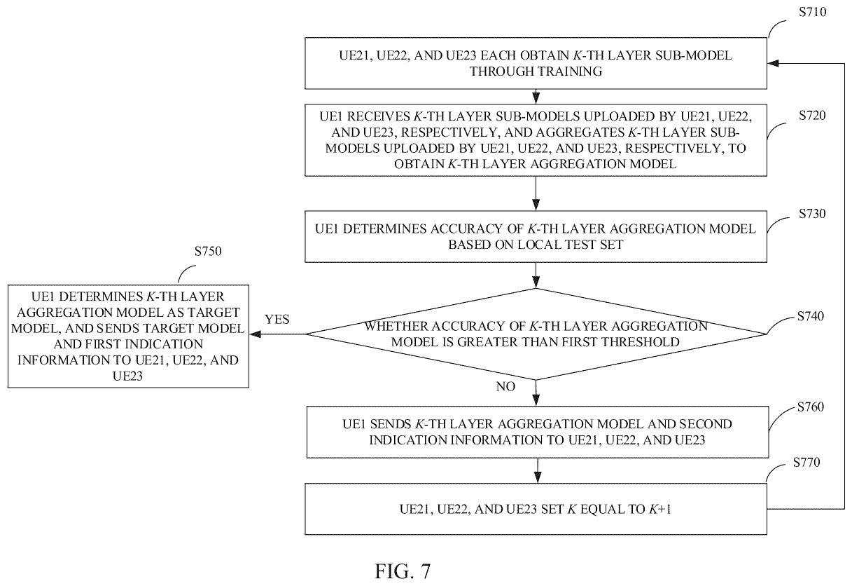

The foregoing manner is exemplified with reference to FIG. 7. Assuming that the first device is UE1, and the multiple second devices are UE21, UE22, and UE23, respectively. In other words, UE1 serves as the master node, and UE21 to UE23 serve as three child nodes. The model generation method can include the following.

S710, UE21, UE22, and UE23 each obtain the k-th layer sub-model through training.

Before the operations at S710 are performed, the method can further include the following. An available UE with the optimal performance is selected as the first device (UE1), i.e., the master node, from multiple UEs in one region, and the rest of the UEs serve as the child nodes, i.e., the second devices. The master node (UE1) will perform aggregation, and an available mobile terminal with the optimal performance is selected as the master node, which can reduce the training time.

In addition, before the operations at S710 are performed, UE1, UE21, UE22, and UE23 each can preprocess its local dataset, and for the specific processing manner, reference can be made to that of the foregoing implementation, which is not repeated herein.

For the processing of UE21, UE22, and UE23 each obtaining the k-th layer sub-model through training, a manner of each UE obtaining the k-th layer sub-model through training is the same as that of the foregoing implementation. It can be understood that different UEs use their respective local training sets for training, and thus model parameters of different k-th layer sub-models obtained through training by different UEs may be different, so that a final obtained target model can be ensured to be applicable to more scenarios with higher accuracy.

S720, UE1 receives k-th layer sub-models uploaded by UE21, UE22, and UE23, respectively, and aggregates the k-th layer sub-models uploaded by UE21, UE22, and UE23, respectively, to obtain the k-th layer aggregation model.

S730, UE1 determines the accuracy of the k-th layer aggregation model based on the local test set.

740, UE1 determines whether the accuracy of the k-th layer aggregation model is greater than the first threshold. If the accuracy of the k-th layer aggregation model is greater than the first threshold, operations at S750 are performed, otherwise, operations at S760 are performed.

S750, UE1 determines the k-th layer aggregation model as the target model, and sends the target model and the first indication information to UE21, UE22, and UE23, where the first indication information indicates to detect, based on the target model, whether the communication data from the mobile network is the intrusion-type data. The processing is completed.

The target model includes at least one of: one or more random forests, or one or more completely random forests.

S760, UE1 sends the k-th layer aggregation model and the second indication information to UE21, UE22, and UE23, where the second indication information indicates that the (k+1)-th layer sub-model is to be generated based on the k-th layer aggregation model.

S770, UE21, UE22, and UE23 set k equal to k+1, and return to perform the operations at S710.

In another manner, after the k-th layer aggregation model is generated, the method further includes the following. The first device sends the k-th layer aggregation model and third indication information, where the third indication information indicates that each second device is to calculate a reference value of the accuracy of the k-th layer aggregation model. The first device receives one or more reference values of the accuracy of the k-th layer aggregation model. The first device determines an average value of the one or more reference values of the accuracy of the k-th layer aggregation model as the accuracy of the k-th layer aggregation model.

In the processing by each second device, the method further includes the following. The second device receives the k-th layer aggregation model and the third indication information, where the third indication information indicates that the reference value of the accuracy of the k-th layer aggregation model is to be calculated. The second device determines the reference value of the accuracy of the k-th layer aggregation model based on the local test set, where the local test set is partial data in the local dataset. The second device sends the reference value of the accuracy of the k-th layer aggregation model.

The processing of the second device determining the reference value of the accuracy of the k-th layer aggregation model based on the local test set, reference can be made to the processing of determining the accuracy of the k-th layer aggregation model, except that each second device uses the proportion of correct classifications obtained finally as the reference value of the accuracy of the k-th layer aggregation model, which is not repeated herein.

In this manner, after the first device obtains the k-th layer aggregation model, the first device sends the k-th layer aggregation model to each second device, and each second device determines the reference value of the accuracy based on its local test set. After the first device has received the reference value of the accuracy from each second device, the first device calculates the average value, and determines the average value as the accuracy of the k-th layer aggregation model.

Optionally, in this manner, the first device can also calculate the reference value of the accuracy of the k-th layer aggregation model.

Specifically, the method further includes the following. The first device determines a reference value of local accuracy of the k-th layer aggregation model based on the local test set, where the local test set is partial data in the local dataset. The first device determines the average value of the one or more reference values of the accuracy of the k-th layer aggregation model as the accuracy of the k-th layer aggregation model as follows. The first device determines an average value of the reference value of the local accuracy of the k-th layer aggregation model and the one or more reference values of the accuracy of the k-th layer aggregation model as the accuracy of the k-th layer aggregation model. For a manner of the first device calculating the reference value of the local accuracy, reference can be made to the manner of the second device calculating the reference value of the accuracy, which is not repeated herein.

With this approach, each device can calculate the reference value of the accuracy by using its own local test set, which can lead to a more accurate accuracy in the end.

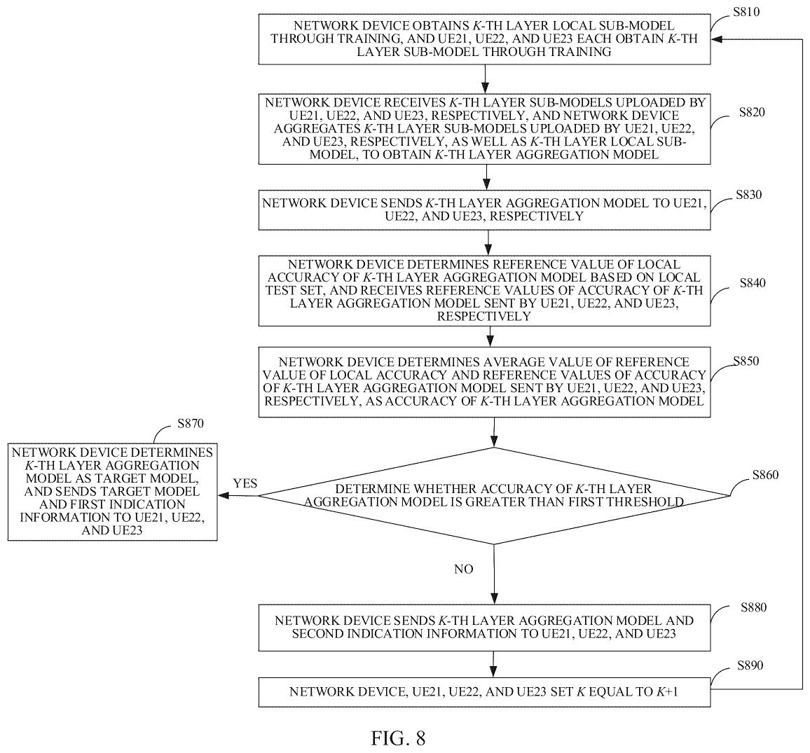

The foregoing manner is exemplified with reference to FIG. 8. Assuming that the first device is the network device, and the multiple second devices are UE21, UE22, and UE23, respectively. In other words, UE1 serves as the master node, and UE21 to UE23 serve as three child nodes. The model generation method can include the following.

S810, the network device obtains the k-th layer local sub-model through training, and UE21, UE22, and UE23 each obtain the k-th layer sub-model through training.

In addition, before the operations at S810 are performed, the network device, UE 21, UE 22, and UE 23 each can preprocess its local dataset, and for the specific processing manner, reference can be made to that of the foregoing implementation, which is not repeated herein. For the processing of obtaining the k-th layer sub-model through training, reference can be made to that of the foregoing implementation.

S820, the network device receives k-th layer sub-models uploaded by UE21, UE22, and UE23, respectively, and the network device aggregates the k-th layer sub-models uploaded by UE21, UE22, and UE23, respectively, as well as the k-th layer local sub-model, to obtain the k-th layer aggregation model.

S830, the network device sends the k-th layer aggregation model to UE21, UE22, and UE23, respectively.

S840, the network device determines the reference value of the local accuracy of the k-th layer aggregation model based on the local test set, and receives reference values of the accuracy of the k-th layer aggregation model sent by UE21, UE22, and UE23, respectively.

The processing of UE21, UE22, and UE23 can include the following. UE21, UE22, and UE23 each determine the reference value of the accuracy of the k-th layer aggregation model based on its local test set, and send the reference value of the accuracy of the k-th layer aggregation model to the network device.

UE21 is taken as an example for illustration as follows. UE21 receives the k-th layer aggregation model and the third indication information, where the third indication information indicates that the reference value of the accuracy of the k-th layer aggregation model is to be calculated. UE21 determines the reference value of the accuracy of the k-th layer aggregation model based on the local test set. UE21 sends the reference value of the accuracy of the k-th layer aggregation model to the network device. It can be understood that for the specific processing of UE22 and UE23, reference can be made to that of UE21, which will not be repeated herein.

S850, the network device determines an average value of the reference value of the local accuracy and the reference values of the accuracy of the k-th layer aggregation model sent by UE21, UE22, and UE23, respectively, as the accuracy of the k-th layer aggregation model.

S860, the network device determines whether the accuracy of the k-th layer aggregation model is greater than the first threshold. If the accuracy of the k-th layer aggregation model is greater than the first threshold, operations at S870 are performed, otherwise, operations at S880 are performed.

S870, the network device determines the k-th layer aggregation model as the target model, and sends the target model and the first indication information to UE21, UE22, and UE23, where the first indication information indicates to detect, based on the target model, whether the communication data from the mobile network is the intrusion-type data. The processing is completed.

S880, the network device sends the k-th layer aggregation model and the second indication information to UE21, UE22, and UE23, where the second indication information indicates that the (k+1)-th layer sub-model is to be generated based on the k-th layer aggregation model.

S890, the network device, UE21, UE22, and UE23 set k equal to k+1, and return to perform the operations at S810.

In another possible implementation, the first device determines the target model based on the one or more k-th layer sub-models as follows. The first device generates the k-th layer aggregation model based on the one or more k-th layer sub-models. When the k-th layer aggregation model and the (k−1)-th layer aggregation model are determined to meet the preset condition, the first device determines the (k−1)-th layer aggregation model as the target model. 189. In this implementation, if the k-th layer aggregation model and the (k−1)-th layer aggregation model are determined to meet the preset condition, the (k−1)-th layer aggregation model is determined as the target model. In other words, the first device keeps saving the (k−1)-th layer aggregation model, i.e., a previous layer aggregation model, and only when the k-th layer aggregation model and the (k−1)-th layer aggregation model are determined not to meet the preset condition, the first device discards or deletes the (k−1)-th layer aggregation model.

Further, the method includes the following. When the k-th layer aggregation model fails to meet the preset condition, the first device sends the k-th layer aggregation model to each of the one or more second devices.

When the first device sends the target model, the method further includes the following. The first device sends the first indication information to each of the one or more second devices, where the first indication information indicates to detect, based on the target model, whether the communication data from the mobile network is the intrusion-type data. Accordingly, when the second device receives the target model, the method further includes the following. The second device receives the first indication information, where the first indication information indicates to detect, based on the target model, whether the communication data from the mobile network is the intrusion-type data.

The target model includes at least one of: one or more random forests, or one or more completely random forests.

It can be noted that if the (k−1)-th layer aggregation model is the target model, the number of random forests in the target model is the sum of the number of random forests in each of multiple (k−1)-th layer sub-models, and similarly, the number of completely random forests in the target model is the sum of the number of completely random forests in each of the multiple (k−1)-th layer sub-models.

Alternatively, in the case where different (k−1)-th layer sub-models have a same random forest and/or a same completely random forest, the first device can also perform deduplication on the same random forest and/or the same completely random forest. In this case, the number of random forests in the target model is the sum of the number of deduplicated random forests in each of the multiple (k−1)-th layer sub-models, and similarly, the number of completely random forests in the target model is the sum of the number of deduplicated completely random forests in each of the multiple (k−1)-th layer sub-models.

When the k-th layer aggregation model is sent to each of the one or more second devices, the method further includes the following. The first device sends the second indication information to each of the one or more second devices, where the second indication information indicates that the (k+1)-th layer sub-model is to be generated based on the k-th layer aggregation model.

Optionally, the first device does not perform sub-model training, and the first device obtains the k-th layer aggregation model only by aggregating the k-th layer sub-model sent by each second device. In addition, the first device will save the (k−1)-th layer aggregation model. For the processing of the first device generating the k-th layer aggregation model based on the one or more k-th layer sub-models, reference can be made to that of the foregoing implementation, which is not repeated herein.

Optionally, the first device performs sub-model training, and the first device obtains the k-th layer aggregation model by aggregating the k-th layer sub-model sent by each second device and the k-th layer local sub-model. In addition, the first device will save the (k−1)-th layer aggregation model. For the processing of the first device generating the k-th layer local sub-mode, reference can be made to that of the foregoing implementation, which is not repeated herein.

The preset condition includes that a difference between the accuracy of the k-th layer aggregation model and the accuracy of the (k−1)-th layer aggregation model is less than the second threshold.

In a manner, the accuracy of the k-th layer aggregation model can be determined by the first device based on the local test set.

For the processing of the first device determining the accuracy of the k-th layer aggregation model based on the local test set, reference can be made to that of the foregoing implementation. Compared with that of the foregoing implementation, in this implementation, the first device saves the accuracy of the (k−1)-th layer aggregation model while saving the (k−1)-th layer aggregation model.

Further, for the processing of the second device performing (k+1)-th training, reference can be made to that of the foregoing implementation, which is not repeated herein.

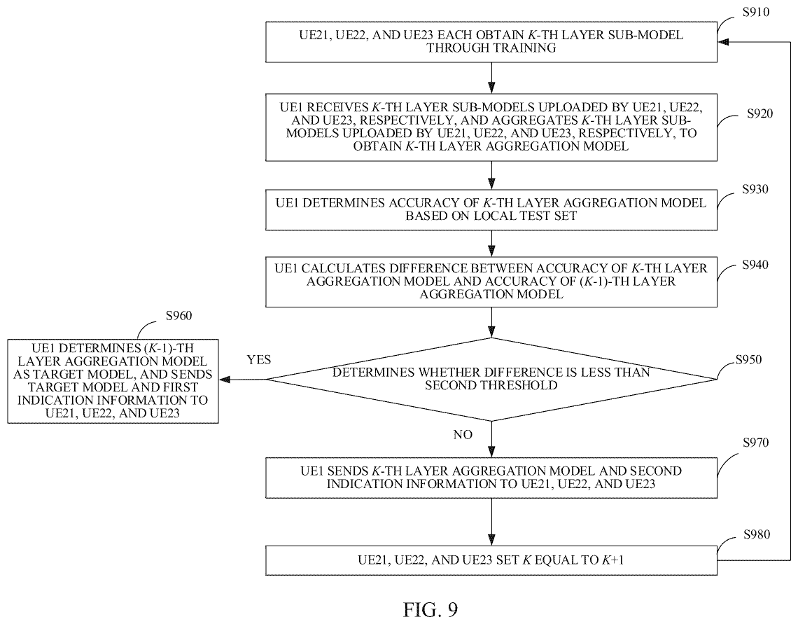

The foregoing manner is exemplified with reference to FIG. 9. Assuming that the first device is UE1, and the multiple second devices are UE21, UE22, and UE23, respectively. In other words, UE1 serves as the master node, and UE21 to UE23 serve as three child nodes. The model generation method can include the following.

S910, UE21, UE22, and UE23 each obtain the k-th layer sub-model through training. 204. S920, UE1 receives k-th layer sub-models uploaded by UE21, UE22, and UE23, respectively, and aggregates the k-th layer sub-models uploaded by UE21, UE22, and UE23, respectively, to obtain the k-th layer aggregation model.

S930, UE1 determines the accuracy of the k-th layer aggregation model based on the local test set.

S940, UE1 calculates the difference between the accuracy of the k-th layer aggregation model and the accuracy of the (k−1)-th layer aggregation model.

S950, UE determines whether the difference is less than the second threshold. If the difference is less than the second threshold, operations at S960 are performed, otherwise, operations at S970 are performed.

For example, the accuracy of the k-th layer aggregation model is denoted as Accₖ the accuracy of the (k−1)-th layer aggregation model is denoted as Accₖ₋₁, and the difference between the two accuracy can be denoted as Accₖ-Accₖ₋₁ The second threshold is denoted as t, and thus the operations at S950 are to determine whether Accₖ-Accₖ₋₁ is less than 1.

S960, UE1 determines the (k−1)-th layer aggregation model as the target model, and sends the target model and the first indication information to UE21, UE22, and UE23, where the first indication information indicates to detect, based on the target model, whether the communication data from the mobile network is the intrusion-type data. The processing is completed.

S970, UE1 sends the k-th layer aggregation model and the second indication information to UE21, UE22, and UE23, where the second indication information indicates that the (k+1)-th layer sub-model is to be generated based on the k-th layer aggregation model.

S980, UE21, UE22, and UE23 set k equal to k+1, and return to perform the operations at S910.

In another manner, after the k-th layer aggregation model is generated, the method further includes the following. The first device sends the k-th layer aggregation model and the third indication information, where the third indication information indicates that each second device is to calculate a reference value of the accuracy of the k-th layer aggregation model. The first device receives one or more reference values of the accuracy of the k-th layer aggregation model. The first device determines an average value of the one or more reference values of the accuracy of the k-th layer aggregation model as the accuracy of the k-th layer aggregation model. 213. In the processing by each second device, the method further includes the following. The second device receives the k-th layer aggregation model and the third indication information, where the third indication information indicates that the reference value of the accuracy of the k-th layer aggregation model is to be calculated. The second device determines the reference value of the accuracy of the k-th layer aggregation model based on the local test set. The second device sends the reference value of the accuracy of the k-th layer aggregation model.

The processing of the second device determining the reference value of the accuracy of the k-th layer aggregation model based on the local test set, reference can be made to that of the foregoing implementation, except that each second device uses the proportion of correct classifications obtained finally as the reference value of the accuracy of the k-th layer aggregation model, which is not repeated herein.

In this manner, after the first device obtains the k-th layer aggregation model, the first device sends the k-th layer aggregation model to each second device, and each second device determines the reference value of the accuracy based on its local test set. After the first device has received the reference value of the accuracy from each second device, the first device calculates the average value, and determines the average value as the accuracy of the k-th layer aggregation model.

Optionally, in this manner, the first device can also calculate the reference value of the accuracy of the k-th layer aggregation model.

Specifically, the method further includes the following. The first device determines the reference value of the local accuracy of the k-th layer aggregation model based on the local test set. The local test set includes one or more test data, where each of the one or more test data includes: a label indicating whether each test data is an intrusion behavior, and one or more test feature values. The first device determines the average value of the one or more reference values of the accuracy of the k-th layer aggregation model as the accuracy of the k-th layer aggregation model as follows. The first device determines the average value of the reference value of the local accuracy of the k-th layer aggregation model and the one or more reference values of the accuracy of the k-th layer aggregation model as the accuracy of the k-th layer aggregation model. For the manner of the first device calculating the reference value of the local accuracy, reference can be made to the manner of the second device calculating the reference value of the accuracy, which is not repeated herein. With this approach, each device can calculate the reference value of the accuracy by using its own local test set, which can lead to a more accurate accuracy in the end.

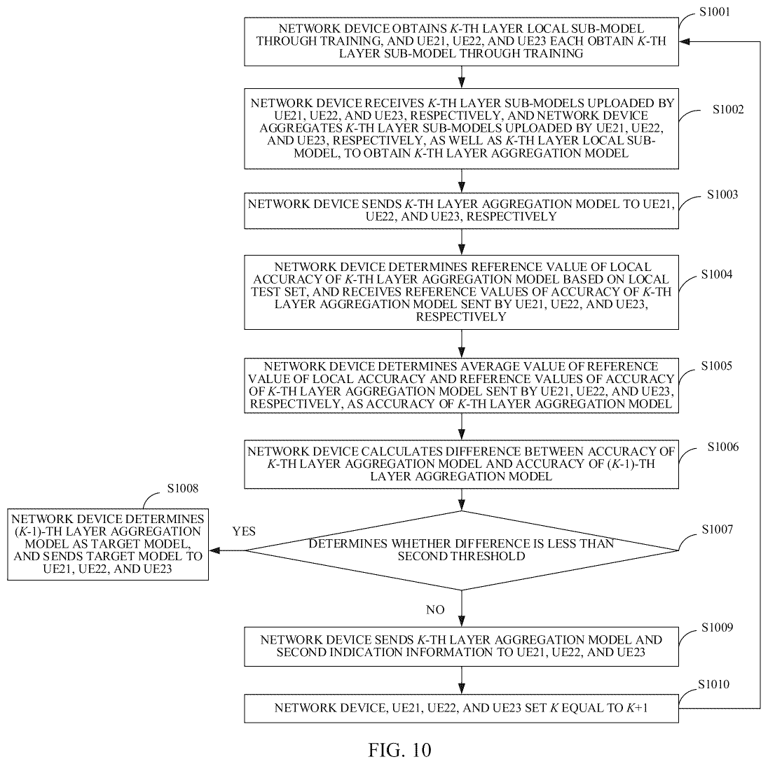

218. The foregoing manner is exemplified with reference to FIG. 10. Assuming that the first device is the network device, and the multiple second devices are UE21, UE22, and UE23, respectively. In other words, UE1 serves as the master node, and UE21 to UE23 serve as three child nodes. The model generation method can include the following. 219. S1001, the network device obtains the k-th layer local sub-model through training, and UE21, UE22, and UE23 each obtain the k-th layer sub-model through training. 220. S1002, the network device receives k-th layer sub-models uploaded by UE21, UE22, and UE23, respectively, and the network device aggregates the k-th layer sub-models uploaded by UE21, UE22, and UE23, respectively, as well as the k-th layer local sub-model, to obtain the k-th layer aggregation model.

221. S1003, the network device sends the k-th layer aggregation model to UE21, UE22, and UE23, respectively.

222. S1004, the network device determines the reference value of the local accuracy of the k-th layer aggregation model based on the local test set, and receives reference values of the accuracy of the k-th layer aggregation model sent by UE21, UE22, and UE23, respectively.

223. The processing of UE21, UE22, and UE23 can include the following. UE21, UE22, and UE23 each determine the reference value of the accuracy of the k-th layer aggregation model based on its local test set, and send the reference value of the accuracy of the k-th layer aggregation model to the network device.

224. S1005, the network device determines the average value of the reference value of the local accuracy and the reference values of the accuracy of the k-th layer aggregation model sent by UE21, UE22, and UE23, respectively, as the accuracy of the k-th layer aggregation model. 225. S1006, the network device calculates the difference between the accuracy of the k-th layer aggregation model and the accuracy of the (k−1)-th layer aggregation model. 226. S1007, the network device determines whether the difference is less than the second threshold. If the difference is less than the second threshold, operations at S1008 are performed, otherwise, operations at S1009 are performed.

S1008, the network device determines the (k−1)-th layer aggregation model as the target model, and sends the target model and the first indication information to UE21, UE22, and UE23, where the first indication information indicates to detect, based on the target model, whether the communication data from the mobile network is the intrusion-type data. The processing is completed.

S1009, the network device sends the k-th layer aggregation model and the second indication information to UE21, UE22, and UE23, where the second indication information indicates that the (k+1)-th layer sub-model is to be generated based on the k-th layer aggregation model.

S1010, the network device, UE21, UE22, and UE23 set k equal to k+1, and return to perform the operations at S1001.

With the above solutions, the target model can be obtained in a federated training manner. Since the sub-model and the target model are generated in different devices respectively, the data security can be guaranteed during the obtainment of the target model at the end. Further, since the target model is obtained by aggregating the multiple sub-models, it can be ensured that the target model is generated more accurately, and that the result of analyzing the communication data from the mobile network based on the target model is more accurate.

In addition, the model used in the solutions is the random forest and/or the completely random forest whose advantages over other types of neural networks are illustrated as follows. Training is performed in other types of deep-learning models, and linear parameters such as a gradient of the model are passed and updated. However, if an attacker disguises itself as a child node to participate in federated learning, a gradient after each round of aggregation can be obtained and then combined with a gradient of a local sub-model of the attacker, and thus local data information of participants of other child nodes can be successfully deduced by calculating a difference or by using a multivariate expression to fit and multiple adjustments and iterations, thereby implementing a label inference attack. In the solutions, the random forest and/or completely random forest are used as the model. The random forest and/or completely random forest are composed of multiple decision trees, and the decision trees complete the classification by outputting class vectors and selecting the maximum in the class vectors in a way similar to voting. For example, in a binary classification, the class vector of [category A, category B] may be [0.3, 0.7] or [0.1, 0.9], but no matter which class vector is output from the model, a final classification result will be category A. Therefore, even if the attacker obtains the classification result, the specific probabilities in the class vector before pre-classification cannot be deduced by combining its own data, so that the local data information of the participants of other child nodes cannot be deduced, thus effectively avoiding the label inference attack.

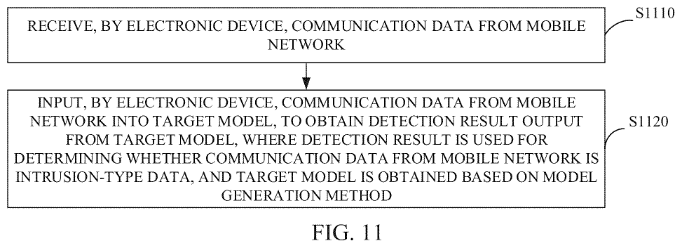

FIG. 11 is a schematic flowchart of an information processing method according to an implementation of the present disclosure. The information processing method includes at least part of the following.

S1110, an electronic device receives communication data from the mobile network.

S1120, the electronic device inputs the communication data from the mobile network into a target model, to obtain a detection result output from the target model, where the detection result is used for determining whether the communication data from the mobile network is intrusion-type data, and the target model is obtained based on the model generation method. 235. In this implementation, the electronic device can be the first device or the second device in the model generation method. For the description of the first device or the second device, reference can be made to that of the foregoing model generation method, which will not be repeated herein. Alternatively, the electronic device may be other devices except the first device and second device. In this case, before the operations at S1110 are performed, the electronic device can receive the target model from either the first device or the second device in advance. 236. The communication data from the mobile network can be carried in any one of the signaling (or messages, or information, or signals) in the mobile network, such as RRC signaling, an MAC CE, a DCI, a system broadcast message, an SL message, etc., which are not listed herein.

The electronic device inputs the communication data from the mobile network into the target model, to obtain the detection result output from the target model as follows. The electronic device converts the communication data from the mobile network into a numerical sequence. The electronic device inputs the numerical sequence into the target model, to obtain the detection result output from the target model.

Converting the communication data from the mobile network into the numerical sequence may be to convert, based on a conversion dictionary, the communication data from the mobile network into the numerical sequence. The conversion dictionary can be preset. Exemplarily, the conversion dictionary can include numbers corresponding to each character or letter. For example, the content of a conversion dictionary D is: {′a′: 1, ‘b’: 2, ‘c’: 3, ‘d’: 4, ‘e’: 5, ‘f’: 6, ‘g’: 7, ‘h’: 8, ‘i’: 9, ‘j’: 10, ‘k’: 11, ‘l’: 12, ‘m’: 13, ‘n’: 14, ‘o’: 15, ‘p’: 16, ‘q’: 17, ‘r’: 18, ‘s’: 19, ‘t’: 20, ‘u’: 21, ‘v’: 22, ‘w’: 23, ‘x’: 24, ‘y’: 25, ‘z’: 26, ‘-’: 2728, ‘1’: 29, ‘2’: 30, ‘3’: 31, ‘4’: 32, ‘5’: 33, ‘6’: 34, ‘7’: 35, ‘8’: 36, ‘9’: 37, ‘0’: 38, “.”: 39, ‘a’: 0}.

In a manner, each training sample in a local training set used for the target model during is single data whose label can indicate whether the data is normal data or abnormal data

When the operations at S1120 are performed, with the target model trained in this manner, input information can be the numerical sequence obtained by converting the communication data from the mobile network. The detection result obtained through the target model can directly indicate whether the communication data from the mobile network is the intrusion-type data.

In another manner, the electronic device inputs the numerical sequence into the target model to obtain the detection result output from the target model as follows. The electronic device inputs the numerical sequence and abnormal data into the target model, to obtain the detection result output from the target model, where the detection result indicates whether the numerical sequence and the abnormal data are the same type of data.

Each training sample in the local training set used during the training of the target model is paired data. In the case where the paired data are the same type of data, its label indicates whether the pair data are the same type of data or different types of data.

When the operations at S1120 are performed, with the target model trained in this manner, the currently received communication data from the mobile network needs to be converted into the numerical sequence, then the numerical sequence is paired with the abnormal data, and the paired data is used as the input information. The abnormal data can be a numerical sequence after conversion of an abnormal domain name, where the abnormal domain name can be a DGA domain name.

The method further includes the following. When the detection result indicates that the numerical sequence and the abnormal data are the same type of data, the electronic device determines that the communication data from the mobile network is the intrusion-type data. Additionally/alternatively, when the detection result indicates that the numerical sequence and the abnormal data are not the same type of data, the electronic device determines that the communication data from the mobile network is normal data.

Optionally, there can be one or more abnormal domain names, that is, there can also be one or more abnormal data. Accordingly, the electronic device inputs the numerical sequence and the abnormal data into the target model to obtain the detection result output from the target model, which can mean that the electronic device inputs the numerical sequence and i-th abnormal data into the target model to obtain an i-th detection result output from the target model, where i is a positive integer. The i-th abnormal data is any one of the one or more abnormal data.

Further, the method can include the following. Whether remaining abnormal data exists is determined. If the remaining abnormal data exists, the numerical sequence and (i+1)-th abnormal data are input into the target model, to obtain an (i+1)-th detection result output from the target model. If the remaining abnormal data does not exist, the detection is determined to be completed. The (i+1)-th abnormal data is any one of the remaining abnormal data.

The electronic device can further operate as follows. In the case where any one of multiple detection results indicates that the numerical sequence and the abnormal data are the same type of data, the electronic device determines that the communication data from the mobile network is the intrusion-type date. Additionally/alternatively, in the case where all of the multiple detection results indicate that the numerical sequence and the abnormal data are different types of data, the electronic device determines that the communication data from the mobile network is normal data.

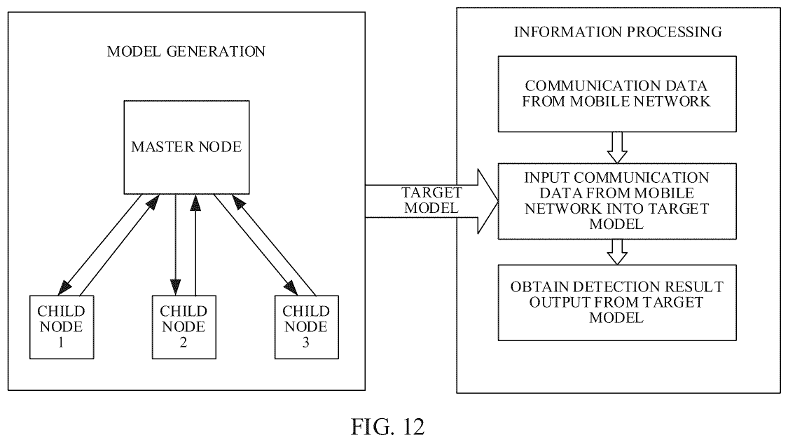

The model generation method and the information processing method are exemplified with reference to FIG. 12. First, federal training can be performed by the first device and the second device, to generate a target model, where the first device can serve as a master node, and the second device can serve as a child node. In the model generation illustrated on the left side of FIG. 12, for example, there are three child nodes, denoted as child node 1, child node 2, and child node 3, respectively. The target model is obtained after the master node and the three child nodes on the left side of FIG. 12 complete their processing, and then the information processing illustrated on the right side of FIG. 12 can be performed. The information processing illustrated on the right side of FIG. 12 can be performed by an electronic device, and the electronic device can be any one of devices on the left side of FIG. 12. In a process illustrated on the right side of FIG. 12, the communication data from the mobile network can be received first, and the communication data from the mobile network is input into the target model, to obtain a detection result output from the target model, where the detection result is used for determining whether the communication data from the mobile network is the intrusion-type data.

With the above solution, the target model can be obtained through federated training, and since the target model is obtained by aggregating multiple sub-models, it can be ensured that the target model is generated more accurately, and that the result of analyzing the communication data from the mobile network based on the target model is more accurate.

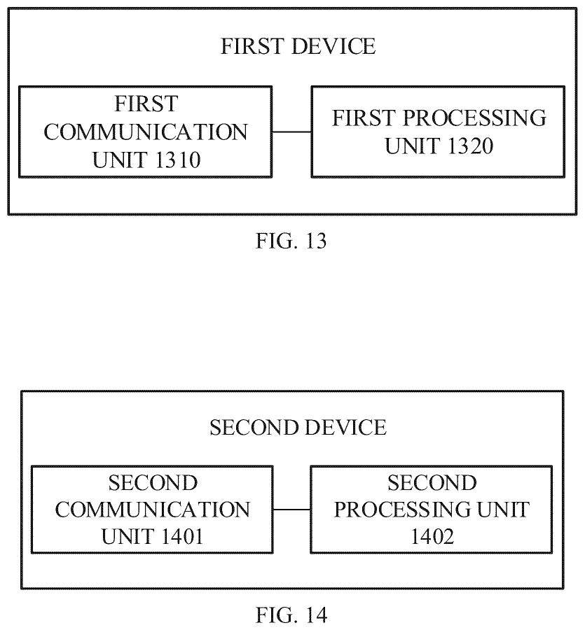

FIG. 13 is a schematic structural diagram of composition of a first device according to an implementation of the present disclosure. The first device includes a first communication unit 1310 and a first processing unit 1320. The first communication unit 1310 is configured to receive one or more k-th layer sub-models and send a target model, where k is a positive integer. The first processing unit 1320 is configured to determine the target model based on the one or more k-th layer sub-models, where the target model is used for detecting whether communication data from a mobile network is intrusion-type data.

The first communication unit is configured to receive a k-th layer sub-model from each of one or more second devices, and send the target model to each of the one or more second devices.

The first processing unit is configured to generate a k-th layer aggregation model based on the one or more k-th layer sub-models, and determine the k-th layer aggregation model as the target model when the k-th layer aggregation model meets a preset condition.

The first processing unit is configured to send, via the first communication unit, the k-th layer aggregation model to each of the one or more second devices when the k-th layer aggregation model fails to meet the preset condition.

The first processing unit is configured to generate a k-th layer aggregation model based on the one or more k-th layer sub-models, and determine, by the first device, a (k−1)-th layer aggregation model as the target model when the k-th layer aggregation model and the (k−1)-th layer aggregation model meet a preset condition.

The first processing unit is configured to send, via the first communication unit, the k-th layer aggregation model to each of the one or more second devices when the k-th layer aggregation model and the (k−1)-th layer aggregation model fail to meet the preset condition. 256. The preset condition includes that accuracy of the k-th layer aggregation model is greater than a first threshold.

The preset condition includes that a difference between accuracy of the k-th layer aggregation model and accuracy of the (k−1)-th layer aggregation model is less than a second threshold.

The first communication unit is configured to send first indication information to each of the one or more second devices, where the first indication information indicates to detect, based on the target model, whether the communication data from the mobile network is the intrusion-type data.

The first communication unit is configured to send second indication information to each of the one or more second devices, where the second indication information indicates that a (k+1)-th layer sub-model is to be generated based on the k-th layer aggregation model.

The first processing unit is configured to generate a k-th layer local sub-model based on a local training set and the (k−1)-th layer aggregation model, where the local training set is partial data in a local dataset, and generate the k-th layer aggregation model based on the k-th layer local sub-model and the one or more k-th layer sub-models.

The first processing unit is configured to determine the accuracy of the k-th layer aggregation model based on a local test set, where the local test set is partial data in the local dataset.

The first communication unit is configured to send the k-th layer aggregation model and third indication information, where the third indication information indicates that each of the one or more second devices is to calculate a reference value of the accuracy of the k-th layer aggregation model. The first communication unit is configured to receive one or more reference values of the accuracy of the k-th layer aggregation model.

The first processing unit is configured to determine an average value of the one or more reference values of the accuracy of the k-th layer aggregation model as the accuracy of the k-th layer aggregation model.

The first processing unit is configured to determine a reference value of local accuracy of the k-th layer aggregation model based on the local test set, where the local test set is partial data in the local dataset. The first processing unit is configured to determine an average value of the reference value of the local accuracy of the k-th layer aggregation model and the one or more reference values of the accuracy of the k-th layer aggregation model as the accuracy of the k-th layer aggregation model.

The local dataset includes one or more sample data, where each of the one or more sample data includes: a label indicating whether each of the one or more sample data is an intrusion behavior, and a feature value, or each of the one or more sample data includes: a feature value of each of two sub-data, and a label indicating whether the two sub-data are the same type of data

The target model includes at least one of: one or more random forests, or one or more completely random forests.

The first device is a terminal device or a network device.

The network device is one of: an AN device, a CN device, and a server.

The server is an EAS, and the CN device is a PGW.

The second device is a terminal device.

The first device in implementations of the present disclosure can implement corresponding functions of the first device in the foregoing implementations of the method for model genration. For the procedure, function, implementation, and advantage corresponding to each module (sub-module, unit, or assembly, etc.) in the first device, reference can be made to the corresponding illustrations in the foregoing method implementations, which will not be described in detail again herein. It can be noted that, the functions of various modules (sub-modules, units, or assemblies, etc.) in the first device described in implementations of the present disclosure may be implemented by different modules (sub-modules, units, or assemblies, etc.), or may be implemented by the same module (sub-module, unit, or assembly, etc.).

FIG. 14 is a schematic structural diagram of composition of a second device according to an implementation of the present disclosure. The second device includes a second communication unit 1401. The second communication unit is configured to send a k-th layer sub-model, where k is a positive integer, and the k-th layer sub-model is used for determining a target model. The second communication unit is configured to receive the target model, where the target model is used for detecting whether communication data from a mobile network is intrusion-type data.

The second communication unit is configured to receive first indication information, where the first indication information indicates to detect, based on the target model, whether the communication data from the mobile network is the intrusion-type data.

The second communication unit is configured to receive a k-th layer aggregation model and second indication information, where the second indication information indicates that a (k+1)-th layer sub-model is to be generated based on the k-th layer aggregation model. The second device further includes a second processing unit 1402. The second processing unit 1402 is configured to generate the (k+1)-th layer sub-model based on an updated local training set and the k-th layer aggregation model.

The second processing unit is configured to input a j-th training sample in a local training set into the k-th layer aggregation model, to obtain a feature vector output from the k-th layer aggregation model, where the local training set is partial data in a local dataset, and j is a positive integer. The second processing unit is configured to down-sample randomly one or more training feature values of the j-th training sample, to obtain a processed training feature value of the j-th training sample. The second processing unit is configured to obtain a j-th training sample in the updated local training set based on the processed training feature value of the j-th training sample and the feature vector output from the k-th layer aggregation model.

The second processing unit is configured to determine a reference value of accuracy of the k-th layer aggregation model based on a local test set, where the local test set is partial data in the local dataset. The second communication unit configured to receive the k-th layer aggregation model and third indication information, where the third indication information indicates that the reference value of the accuracy of the k-th layer aggregation model is to be calculated. The second communication unit configured to send the reference value of the accuracy of the k-th layer aggregation model.

The local dataset includes one or more sample data, where each of the one or more sample data includes: a label indicating whether each of the one or more sample data is an intrusion behavior, and a feature value, or each of the one or more sample data includes: a feature value of each of two sub-data, and a label indicating whether the two sub-data are the same type of data.

The target model includes at least one of: one or more random forests, or one or more completely random forests.

The second device is a terminal device.

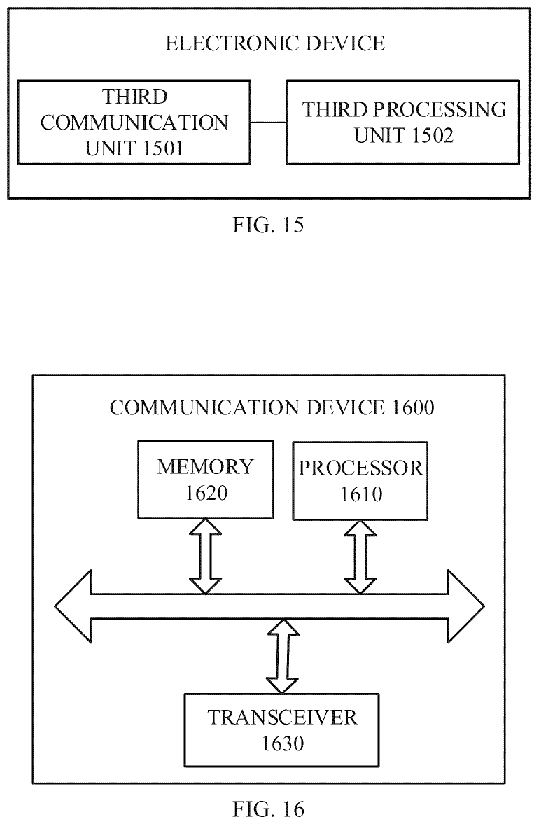

The second device in implementations of the present disclosure can implement corresponding functions of the second device in the foregoing implementations of the method for model genration. For the procedure, function, implementation, and advantage corresponding to each module (sub-module, unit, or assembly, etc.) in the second device, reference can be made to the corresponding illustrations in the foregoing method implementations, which will not be described in detail again herein. It can be noted that, the functions of various modules (sub-modules, units, or assemblies, etc.) in the second device described in implementations of the present disclosure may be implemented by different modules (sub-modules, units, or assemblies, etc.), or may be implemented by the same module (sub-module, unit, or assembly, etc.). 282. FIG. 15 is a schematic structural diagram of composition of an electronic device according to an implementation of the present disclosure. The electronic device includes a third communication unit 1501 and a third processing unit 1502. The third communication unit 1501 is configured to receive communication data from a mobile network. The third processing unit 1502 is configured to input the communication data from the mobile network into a target model, to obtain a detection result output from the target model, where the detection result is used for determining whether the communication data from the mobile network is intrusion-type data, and the target model is obtained based on the model generation method.

The third processing unit is configured to convert the communication data from the mobile network into a numerical sequence, and input the numerical sequence into the target model, to obtain the detection result output from the target model.

The third processing unit is configured to input the numerical sequence and abnormal data into the target model, to obtain the detection result output from the target model, where the detection result indicates whether the numerical sequence and the abnormal data are the same type of data

The third processing unit is configured to determine that the communication data from the mobile network is the intrusion-type data when the detection result indicates that the numerical sequence and the abnormal data are the same type of data. Additionally/alternatively, the third processing unit is configured to determine that the communication data from the mobile network is normal data when the detection result indicates that the numerical sequence and the abnormal data are not the same type of data.

The target model includes at least one of: one or more random forests, or one or more completely random forests.

The electronic device in implementations of the present disclosure can implement corresponding functions of the electronic device in the foregoing implementations of the method for model genration. For the procedure, function, implementation, and advantage corresponding to each module (sub-module, unit, or assembly, etc.) in the electronic device, reference can be made to the corresponding illustrations in the foregoing method implementations, which will not be described in detail again herein. It can be noted that, the functions of various modules (sub-modules, units, or assemblies, etc.) in the electronic device described in implementations of the present disclosure may be implemented by different modules (sub-modules, units, or assemblies, etc.), or may be implemented by the same module (sub-module, unit, or assembly, etc.).

FIG. 16 is a schematic structural diagram of a communication device 1600 according to implementations of the present disclosure. The communication device 1600 includes a processor 1610. The processor 1610 can invoke and execute a computer program stored in a memory, to cause the communication device 1600 to implement the method in implementations of the present disclosure.

In a possible implementation, the communication device 1600 can further include a memory 1620. The processor 1610 can invoke and execute a computer program stored in the memory 1620, to cause the communication device 1600 to implement the method in implementations of the present disclosure.

The memory 1620 can be a separate device independent of the processor 1610, or can be integrated into the processor 1610.

In a possible implementation, the communication device 1600 may further include a transceiver 630. The processor 1610 can control the transceiver 1630 to communicate with other devices, and specifically, to send information or data to other devices or receive information or data sent by other devices.

The transceiver 1630 may include a transmitter and a receiver. The transceiver 1630 can further include an antenna, where one or more antennas may be provided.

In a possible implementation, the communication device 1600 can be the first device in implementations of the present disclosure, and the communication device 1600 can implement corresponding operations implemented by the first device in various methods in implementations of the present disclosure, which is not repeated herein for the sake of brevity.

In a possible implementation, the communication device 1600 can be the second device in implementations of the present disclosure, and the communication device 1600 can implement corresponding operations implemented by the second device in various methods in implementations of the present disclosure, which is not repeated herein for the sake of brevity.

In a possible implementation, the communication device 1600 can be the electronic device in implementations of the present disclosure, and the communication device 1600 can implement corresponding operations implemented by the electronic device in various methods in implementations of the present disclosure, which is not repeated herein for the sake of brevity.

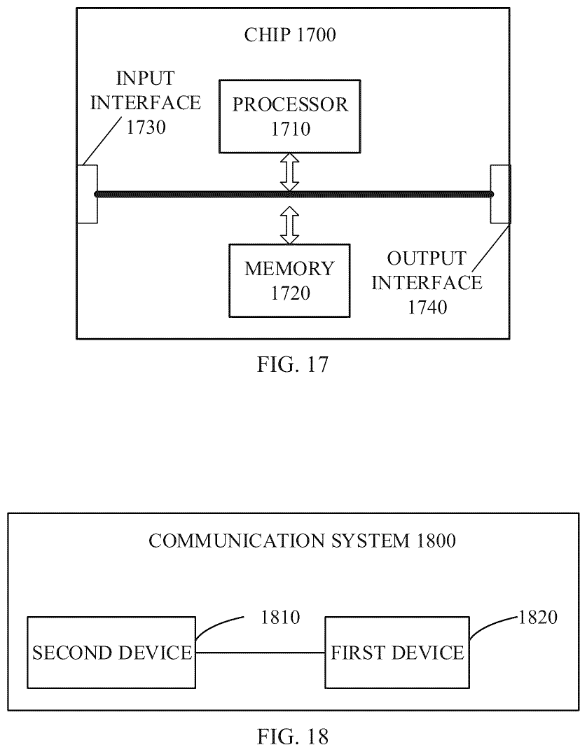

FIG. 17 is a schematic structural diagram of a chip 1700 according to implementations of the present disclosure. The chip 1700 includes a processor 1710. The processor 1710 can invoke and execute a computer program stored in a memory, to implement the method in implementations of the present disclosure.

In a possible implementation, the chip 1700 can further include a memory 1720. The processor 1710 can invoke and execute a computer program stored in the memory 1720, to implement the method implemented by the electronic device, the second device, and the first device in implementations of the present disclosure.

The memory 1720 can be a separate device independent of the processor 1710, or can be integrated into the processor 1710.

In a possible implementation, the chip 1700 can further include an input interface 1730. The processor 1710 can control the input interface 1730 to communicate with other devices or chips, and specifically, to obtain information or data sent by other devices or chips.

In a possible implementation, the chip 1700 can further include an output interface 1740. The processor 1710 can control the output interface 1740 to communicate with other devices or chips, and specifically, to output information or data to other devices or chips. 301. In a possible implementation, the chip can be applied to the first device in implementations of the present disclosure, and the chip can implement corresponding operations implemented by the first device in various methods in implementations of the present disclosure, which is not repeated herein for the sake of brevity.

In a possible implementation, the chip can be applied to the second device in implementations of the present disclosure, and the chip can implement corresponding operations implemented by the second device in various methods in implementations of the present disclosure, which is not repeated herein for the sake of brevity.

In a possible implementation, the chip can be applied to the electronic device in implementations of the present disclosure, and the chip can implement corresponding operations implemented by the electronic device in various methods in implementations of the present disclosure, which is not repeated herein for the sake of brevity.

The chip applied to the first device, the chip applied to the electronic device, and the chip applied to the second device can be the same as or different from each other.

305. It can be understood that the chip mentioned in implementations of the present disclosure can also be referred to as a system-on-chip (SOC).

The processor can be a general-purpose processor, a digital signal processor (DSP), an application-specific integrated circuit (ASIC), a field programmable gate array (FPGA), or other programmable logic devices, discrete gates or transistor logic devices, discrete hardware components. The general-purpose processor can be a microprocessor, any conventional processor, etc.

The memory can be a volatile memory or a non-volatile memory, or can include both the volatile memory and the non-volatile memory. The non-volatile memory can be a read-only memory (ROM), a programmable ROM (PROM), an erasable PROM (EPROM), an electrically EPROM (EEPROM), or a flash memory. The volatile memory can be a random access memory (RAM).

It can be understood that the memory above is intended for illustration rather than limitation. For example, the memory in implementations of the present disclosure can also be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. In other words, the memory in implementations of the present disclosure is intended to include, but is not limited to, these and any other suitable types of memory.

FIG. 18 is a schematic block diagram of a communication system 1800 according to implementations of the present disclosure. The communication system 1800 includes a second device 1810 and a first device 1820.

The second device 1810 can be configured to implement corresponding functions implemented by the second device in the method mentioned above, and the first device 1820 can be configured to implement corresponding functions implemented by the first device in the method mentioned above, which are not repeated herein for the sake of brevity. 311. All or some of the above implementations can be implemented through software, hardware, firmware, or any other combination thereof. When implemented by software, all or some of the above implementations can be implemented in the form of a computer program product. The computer program product includes one or more computer instructions. When the computer instructions are applied and executed on a computer, all or some of the operations or functions of the implementations of the present disclosure are performed. The computer can be a general-purpose computer, a special-purpose computer, a computer network, or other programmable apparatuses. The computer instruction can be stored in a computer-readable storage medium, or sent from one computer-readable storage medium to another computer-readable storage medium. For example, the computer instruction can be sent from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It can be understood that, in various implementations of the present disclosure, the magnitude of a sequence number of each process does not mean an order of execution, and the order of execution of each process can be determined by its function and internal logic and shall not constitute any limitation to the implementation of the implementations of the present disclosure.

It will be evident to those skilled in the art that, for the sake of convenience and simplicity, in terms of the specific working processes of the foregoing systems, apparatuses, and units, reference can be made to the corresponding processes in the foregoing method implementations, which is not repeated herein.

The foregoing elaborations are merely implementations of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A model generation method, comprising:
receiving, by a first device, one or more k-th layer sub-models, wherein k is a positive integer;
determining, by the first device, a target model based on the one or more k-th layer sub-models, wherein the target model is used for detecting whether communication data from a mobile network is intrusion-type data; and
sending, by the first device, the target model.

2. The method of claim 1, wherein:
receiving, by the first device, the one or more k-th layer sub-models comprises:
receiving, by the first device, a k-th layer sub-model from each of one or more second devices; and
sending, by the first device, the target model comprises:
sending, by the first device, the target model to each of the one or more second devices.

3. The method of claim 2, wherein determining, by the first device, the target model based on the one or more k-th layer sub-models comprises:
generating, by the first device, a k-th layer aggregation model based on the one or more k-th layer sub-models; and
determining, by the first device, the k-th layer aggregation model as the target model in response to the k-th layer aggregation model meeting a preset condition.

4. The method of claim 3, further comprising:
sending, by the first device, the k-th layer aggregation model to each of the one or more second devices in response to the k-th layer aggregation model failing to meet the preset condition.

5. The method of claim 2, determining, by the first device, the target model based on the one or more k-th layer sub-models comprises:
generating, by the first device, a k-th layer aggregation model based on the one or more k-th layer sub-models; and
determining, by the first device, a (k−1)-th layer aggregation model as the target model in response to the k-th layer aggregation model and the (k−1)-th layer aggregation model meeting a preset condition.

6. The method of claim 5, further comprising:
sending, by the first device, the k-th layer aggregation model to each of the one or more second devices in response to the k-th layer aggregation model and the (k−1)-th layer aggregation model failing to meet the preset condition.

7. A model generation method, comprising:
sending, by a second device, a k-th layer sub-model, wherein k is a positive integer, and the k-th layer sub-model is used for determining a target model; and
receiving, by the second device, the target model, wherein the target model is used for detecting whether communication data from a mobile network is intrusion-type data.

8. The method of claim 7, wherein when receiving, by the second device, the target model, the method further comprises:
receiving, by the second device, first indication information, wherein the first indication information indicates to detect, based on the target model, whether the communication data from the mobile network is the intrusion-type data.

9. The method of claim 7, further comprising:
receiving, by the second device, a k-th layer aggregation model and second indication information, wherein the second indication information indicates that a (k+1)-th layer sub-model is to be generated based on the k-th layer aggregation model.

10. The method of claim 9, further comprising:
generating, by the second device, the (k+1)-th layer sub-model based on an updated local training set and the k-th layer aggregation model.

11. The method of claim 10, further comprising:
inputting, by the second device, a j-th training sample in a local training set into the k-th layer aggregation model, to obtain a feature vector output from the k-th layer aggregation model, wherein the local training set is partial data in a local dataset, and j is a positive integer;
down-sampling randomly, by the second device, one or more training feature values of the j-th training sample, to obtain a processed training feature value of the j-th training sample; and
obtaining, by the second device, a j-th training sample in the updated local training set based on the processed training feature value of the j-th training sample and the feature vector output from the k-th layer aggregation model.

12. The method of claim 7, further comprising:
receiving, by the second device, a k-th layer aggregation model and third indication information, wherein the third indication information indicates that a reference value of accuracy of the k-th layer aggregation model is to be calculated;
determining, by the second device, the reference value of the accuracy of the k-th layer aggregation model based on a local test set, wherein the local test set is partial data in a local dataset; and
sending, by the second device, the reference value of the accuracy of the k-th layer aggregation model.

13. The method of claim 12, wherein the local dataset comprises one or more sample data;
wherein each of the one or more sample data comprises: a label indicating whether each of the one or more sample data is an intrusion behavior, and a feature value; or
wherein each of the one or more sample data comprises: a feature value of each of two sub-data, and a label indicating whether the two sub-data are the same type of data.

14. The method of claim 7, wherein the target model comprises at least one of: one or more random forests, or one or more completely random forests.

15. The method of claim 7, wherein the second device is a terminal device.

16. An information processing method, comprising:
receiving, by an electronic device, communication data from a mobile network; and
inputting, by the electronic device, the communication data from the mobile network into a target model, to obtain a detection result output from the target model, wherein the detection result is used for determining whether the communication data from the mobile network is intrusion-type data, and the target model is obtained based on the method of claim 7.

17. A first device, comprising:
a processor; and
a memory configured to store a computer program, which when executed by the processor, causes the first device to perform the method of claim 1.

18. A second device, comprising:
a processor; and
a memory configured to store a computer program, which when executed by the processor, causes the second device to:
send a k-th layer sub-model, wherein k is a positive integer, and the k-th layer sub-model is used for determining a target model; and
receive the target model, wherein the target model is used for detecting whether communication data from a mobile network is intrusion-type data.

19. The second device of claim 18, wherein the computer program, which when executed by the processor, further causes the second device to:
receive a k-th layer aggregation model and second indication information, wherein the second indication information indicates that a (k+1)-th layer sub-model is to be generated based on the k-th layer aggregation model.

20. A non-transitory computer-readable storage medium configured to store a computer program which, when executed by a device, causes the device to perform the method of claim 7.
